(19) United States
(12) Patent Application Publication
(10) Pub. No.: US 2019/0172007 A1
(43) Pub. Date: Jun. 6, 2019

(54) SYSTEMS AND METHODS FOR TRACKING A SHIPMENT

(71) Applicant: Toyota Motor Engineering & Manufacturing North America, Inc., Erlanger, KY (US)

(72) Inventors: Scott A. Friedman, Dallas, TX (US); Prince R. Remegio, Lewisville, TX (US); Tim Uwe Falkenmayer, Mountain View, CA (US); Roger Akira Kyle, Lewisville, TX (US); Ryoma Kakimi, Ann Arbor, MI (US); Luke D. Heide, Plymouth, MI (US); Nishikant Narayan Puranik, Frisco, TX (US)

(73) Assignee: Toyota Motor Engineering & Manufacturing North America, Inc., Erlanger, KY (US)

(21) Appl. No.: 15/830,724

(22) Filed: Dec. 4, 2017

(51) Int. Cl. G06Q 10/08; G01C 21/36

(52) U.S. Cl. CPC G06Q 10/0833; G06Q 10/109; G01C 21/36

(57) ABSTRACT

Systems and methods for tracking a shipment are provided. One embodiment of a method includes determining a predetermined destination for delivery of a package for a user, where the package is being delivered by a carrier, determining that delivery of the package to the predetermined destination has been interrupted and the package is being delivered to a new destination, and determining a location of the new destination. Some embodiments include providing a user option to route a vehicle to the new destination to retrieve the package and, in response to a user selection of the user option, providing routing of the vehicle to the new destination.

### TECHNICAL FIELD

Embodiments described herein generally relate to systems and methods for tracking a shipment and, more specifically, to embodiments that provide vehicle routing associated with a shipment.

### BACKGROUND

As the internet continues to evolve, consumers are purchasing more goods online for delivery to a home or office. While there are measures in place on the carrier side to only deliver certain packages when a person is present, such measures are often an annoyance for the recipient. As such, many carriers now provide real-time or near real time shipping updates to provide the recipient with information regarding a time that the package will arrive. These measures provide good information, but still fall short to ensure proper delivery of the package.

### SUMMARY

Systems and methods for tracking a shipment are provided. One embodiment of a method includes determining a predetermined destination for delivery of a package for a user, where the package is being delivered by a carrier, determining that delivery of the package to the predetermined destination has been interrupted and the package is being delivered to a new destination, and determining a location of the new destination. Some embodiments include providing a user option to route a vehicle to the new destination to retrieve the package and, in response to a user selection of the user option, providing routing of the vehicle to the new destination.

In another embodiment, a system includes a user computing device that includes a processor and a memory component that stores logic that, when executed by the processor, causes the system to determine a time that a package will arrive at a predetermined destination, where the package is being delivered by a carrier, predict a current location of a vehicle, and determine whether the vehicle can be located at the predetermined destination at the time. In some embodiments, the logic causes the system to route the vehicle to the predetermined destination and indicate presence of the vehicle at the predetermined destination, in response to determining that the vehicle can be located at the predetermined destination at the time. In some embodiments, the logic causes the system to provide instructions for the carrier, in response to determining that the vehicle cannot be located at the predetermined destination at the time.

In yet another embodiment, a vehicle computing device includes a processor and a memory component that is coupled to the processor and stores logic that, when executed by the processor, causes the vehicle computing device to determine a predetermined destination and a predetermined time for delivery of a package for a user, where the package is being delivered by a carrier, and determine that the package cannot be delivered to the predetermined destination at the predetermined time. In some embodiments, the logic causes the vehicle computing device to determine a new destination and a different time for delivering the package, in response to determining that the package cannot be delivered and provide a user option to route a vehicle to the new destination to retrieve the package at the new destination and the different time. In some embodiments, the logic causes the vehicle computing device to provide routing of the vehicle to the new destination, in response to a user selection of the user option.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for tracking shipments, according to embodiments described herein;

FIG. 2 depicts a vehicle interior for tracking a shipment, according to embodiments described herein;

FIG. 3 depicts a user interface for tracking a package, according to embodiments described herein;

FIG. 4 depicts a user interface for routing the user vehicle to a package, according to embodiments described herein;

FIG. 5 depicts a user interface for receiving delivery of a package, according to embodiments described herein;

FIG. 6 depicts a user interface for sending a message to a carrier, according to embodiments described herein;

FIG. 7 depicts a flowchart for routing a vehicle to a package, according to embodiments described herein;

FIG. 8 depicts a flowchart for providing delivery instructions to a carrier, according to embodiments described herein; and

FIG. 9 depicts a vehicle computing device for tracking a shipment, according to embodiments described herein.

### DETAILED DESCRIPTION

Embodiments disclosed herein include systems and methods for tracking a shipment. Some embodiments may be configured to provide a status of a package to a user on demand. Embodiments can also make arrangements for the user with respect to the package.

Specifically, a vehicle and/or a portable communication device can include a virtual agent operating thereon. The virtual agent may be configured to assist a user with one or more tasks. User information about various shipping service providers (e.g., FedEx™, USPS™, UPS™, etc.) can be stored on the vehicle, the portable communication device, and/or remotely (e.g., in the cloud). Such information can include login credentials for the user's account with a particular shipping service and/or tracking numbers input by the user.

The vehicle/portable communication device can include a voice receiver system (e.g., microphones) and any suitable voice recognition technology that can analyze received voice inputs. Embodiments can be configured to analyze user voice inputs (and/or other inputs) to determine whether such inputs include an inquiry/command regarding a package. For example, the user can ask where their FedEx™, USPS™, and UPS™ shipments are located. These embodiments may be connected to one or more shipping services, such as via the Internet. As such, embodiments may be configured to submit tracking number information to the provider or can otherwise login to the user's account at that service provider. In either case, these embodiments may obtain package status information from the service provider and may present the pertinent information in an audial manner.

Some embodiments may be configured to determine how to proceed in certain circumstances. For example, if a delivery was interrupted or otherwise not completed because the user was not home and if the package is being held at a shipping service provider location, embodiments may advise the user of the status. These embodiments may also determine whether the carrier location is located on the user's current route. If so, embodiments may ask the user whether he or she wishes to pick up the package and/or whether the provider should be notified. These embodiments can be configured to automatically route the user to the location. The systems and methods for tracking a shipment incorporating the same will be described in more detail, below.

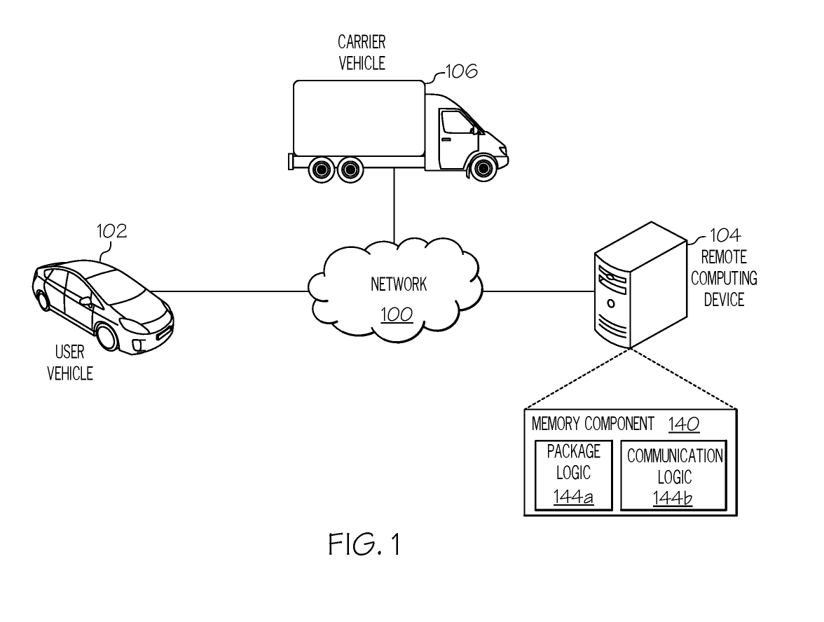

Referring now to the drawings, FIG. 1 depicts a computing environment for tracking shipments, according to embodiments described herein. As illustrated, a network 100 may include a wide area network, such as the internet, a cellular network, a public switch telephone network, and the like. Similarly, the network 100 may include a local network, such as a local area network, a wireless fidelity (Wi-Fi) network, and the like. Further, the network 100 may represent the capability to facilitate device-to-device communications without or without an intermediary.

Coupled to the network are a user vehicle 102, a remote computing device 104, and a carrier vehicle 106. Specifically, the user vehicle 102 may include any land-based, water-based, or air-based vehicle. The user vehicle 102 may be configured for communicating with the remote computing device 104 and/or the carrier vehicle 106. As such, the user vehicle 102 may include one or more computing device for facilitating communication via the network 100 and/or for interfacing with a mobile device (such as a mobile phone) to facilitate the communication. The user vehicle 102 may also include a positioning system to determine a vehicle route from a current location to a predetermined destination or new destination.

The remote computing device 104 may include a personal computer, server, mobile computing device, and/or other similar device for facilitating communication between the user vehicle 102 and the carrier vehicle 106. As such, the remote computing device 104 may include a memory component 140 that stores package logic 144a, communication logic 144b, and/or other logic. The package logic 144a may be configured to cause the remote computing device 104 to determine delivery information related to a package (such as the carrier vehicle 106). Similarly, the package logic 144a may additionally be configured to cause the remote computing device 104 to facilitate changes of delivery destination, as described in more detail below. Similarly, the communication logic 144b may facilitate communication between the user vehicle 102, the carrier vehicle 106, and/or other devices.

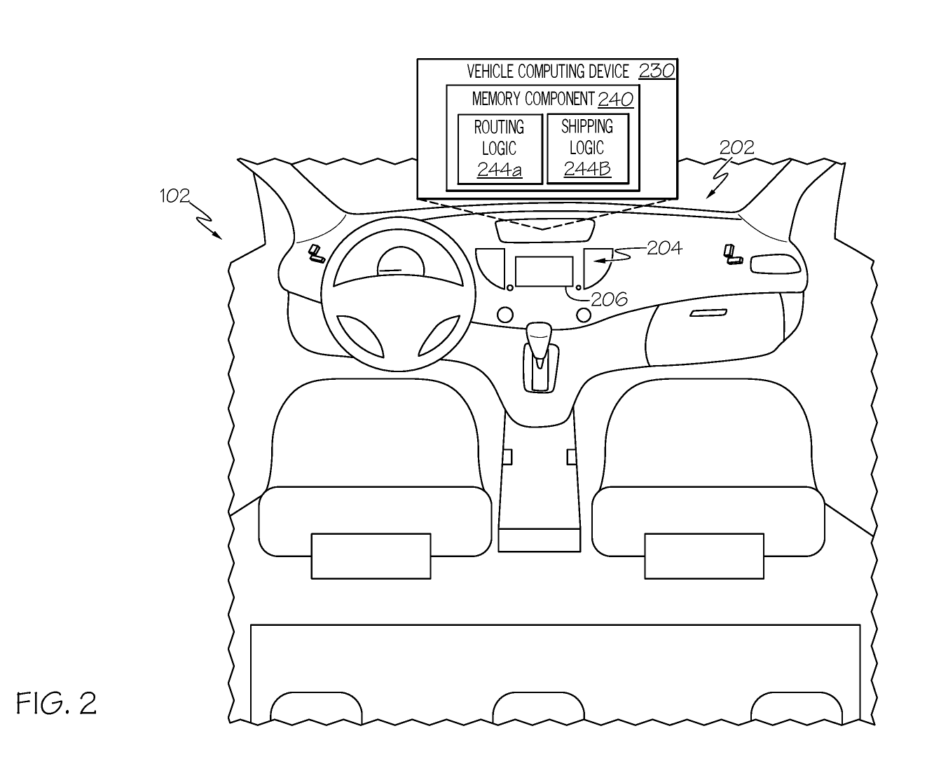

FIG. 2 depicts a vehicle interior 202 for tracking a shipment, according to embodiments described herein. As illustrated, the vehicle interior 202 of the user vehicle 102 may include a vehicle head unit 204. The vehicle head unit 204 may include a display device 206 for providing one or more user interfaces described herein. The vehicle head unit 204 may additionally include and/or provide a voice recognition system, a positioning system, and/or other infotainment systems and/or services. Specifically, the voice recognition system may include one or more microphones, one or more speakers, as well as logic for performing voice recognition and virtual assistant capabilities. Depending on the embodiment, the voice recognition system may include cloud-based logic (accessed via the network 100) and/or may perform voice recognition locally. Additionally, the vehicle head unit 204 may include and/or be configured to interface with a positioning system.

The user vehicle 102 and/or vehicle head unit 204 may additionally include a vehicle computing device 230, which may include a memory component 240. The memory component 240 may include routing logic 244a and shipping logic 244b. The routing logic 244a may be part of the positioning system for determining a current position and routing the user vehicle 102 to a predetermined destination and/or new destination. Similarly, the shipping logic 244b may be configured to cause the vehicle computing device 230 to determine shipping status, change shipping status, and/or communicate with the remote computing device 104 and/or carrier vehicle 106.

It should be understood that while the vehicle computing device 230 is depicted in FIG. 2 as being integrated into the user vehicle 102, this is merely an example. Some embodiments may be configured such that any user device, such as a mobile device or other user device may provide the functionality described herein. If a mobile device is utilized, these embodiments may or may not physically integrate with the vehicle head unit 204 to provide the described functionality.

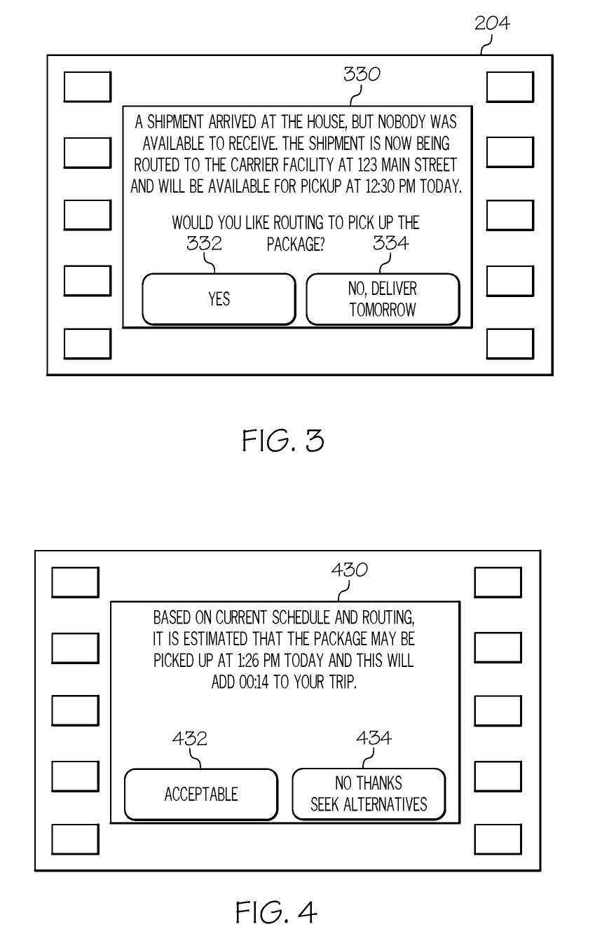

FIG. 3 depicts a user interface 330 for tracking a package, according to embodiments described herein. As illustrated, the user interface 330 may indicate a current status of a package delivery. Specifically, a package may be shipped to a predetermined destination via a carrier to a user. Once shipment has begun, the carrier (e.g., via the remote computing device 104) may track the location and status of the delivery. In some embodiments, the carrier may also predict an expected delivery time of the package to the predetermined destination. In some embodiments, the carrier may determine and/or receive instructions such that delivery can only be completed if the user is present at the predetermined destination to accept delivery.

If the carrier attempts to complete the delivery, but is unable to do so, delivery to the predetermined destination may be interrupted. As such, embodiments described herein may be configured to notify the user via the user interface 330. Specifically, the remote computing device 104 (and/or the carrier vehicle 106) may send a message indicating that shipment could not be completed because nobody was present at the predetermined location. The message may also indicate that the package is being instead delivered to a new destination, such as a user-defined destination, a carrier facility, and/or other location.

As a consequence, the user interface 330 may be configured to provide an option for the user to be routed to the new destination. As such, the user interface 330 may provide a yes option 332 and a no option 334. In response to selection the yes option 332, the user device may route the user vehicle 102 to the new destination. In response to selection of the no option 334, the user device may send a signal to the remote computing device 104 to reschedule delivery for another day, time, and/or location.

It should be understood that some embodiments may be configured for the carrier vehicle 106 to create a waypoint to deliver the package. Specifically, if the carrier vehicle 106 is unable to deliver the package to the predetermined destination, the remote computing device 104 may send data related to the user interface 330. The remote computing device 104 may additionally determine whether there is a waypoint that may be created for the carrier vehicle 106. The waypoint may be a user-defined destination and/or may be a retail store or other facility associated with and/or determined by the carrier. As such, some embodiments of the user interface 330 may include options for creating a waypoint for the carrier vehicle 106.

FIG. 4 depicts a user interface 430 for routing the user vehicle 102 to a package, according to embodiments described herein. In response to selection of the yes option 334 (FIG. 3), the user interface 430 may provide information related to a time and place that the package may be retrieved. Specifically, many carriers will send the carrier vehicle 106 to deliver several packages before returning back to the carrier facility. As a result, when the carrier vehicle 106 is unable to deliver a package, that package may be returned back to the carrier facility. However, because there are other packages to deliver, oftentimes, the undeliverable package may not be returned until sometime in the future.

As such, the user interface 430 may provide a predicted time that the package will arrive. Additionally, because the user vehicle 102 may be currently on a vehicle route, the user computing device may determine whether a waypoint may be established along the vehicle route. If a waypoint may be established, the user computing device may determine an added trip time that the waypoint will add to the vehicle route. This information may be provided in the user interface 430.

Also provided in the user interface 430 are an acceptable option 432 and a no option 434. In response to selection of the acceptable option 432, a communication may be sent to the remote computing device 104 to indicate that the user vehicle 102 will retrieve the package from the carrier facility. Additionally, the vehicle route may be amended to include the carrier facility as a waypoint. In response to selection of the no option 434, the user computing device may determine alternatives for delivering the package, such as rescheduling delivery to the predetermined destination, identifying a new destination, identifying a preferred time for delivery, etc.

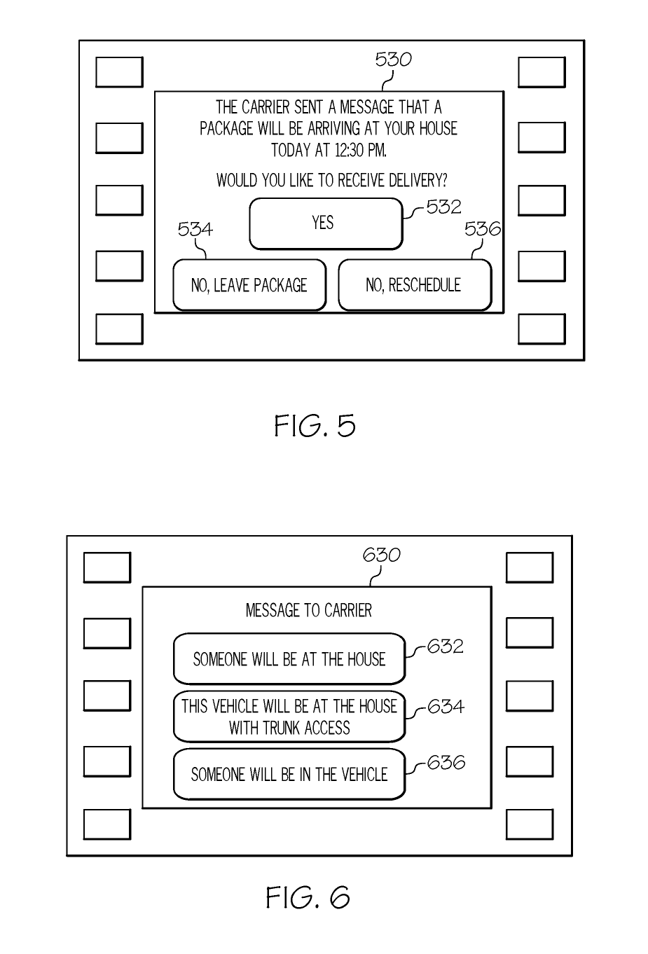

FIG. 5 depicts a user interface 530 for receiving delivery of a package, according to embodiments described herein. As illustrated, the user interface 530 provides information and options associated with a predicted time that the carrier vehicle 106 will deliver a package to a predetermined destination. Specifically, while the user interfaces 330, 430 from FIGS. 3 and 4 respectively are associated with a missed delivery, the user interface 530 applies to embodiments where the carrier actively sends data related to an upcoming delivery. As such, the user interface 530 may provide the user with a predicted time and predicted destination that a package will be delivered.

Also provided are yes option 532, leave package option 534, and a reschedule option 536. In response to selection of the yes option 532, the package will be delivered as requested. In response to selection of the leave package option 534, the carrier may be notified that the user wishes that the package be left at the predetermined destination, regardless of whether someone is present to receive the package. In response to selection of the reschedule option 536, the user may reschedule delivery of the package to a different time and/or destination.

In some embodiments, the user computing device may determine whether the user (or others) will be available to accept the package at the predetermined location and predetermined time. As an example, some embodiments may be configured to determine the current route and then predict whether the vehicle route will be completed prior to delivery and/or, if not, whether the user vehicle 102 may create a waypoint to receive delivery. In some embodiments, the user's calendar may be accessed to further make this determination. Accordingly, one or more of the options in the user interface 530 may be grayed out or otherwise deactivated if an option is not available. In response to selecting the reschedule option 536, unavailable times and/or destinations may be deactivated to prevent the user from scheduling an unavailable option.

FIG. 6 depicts a user interface 630 for sending a message to a carrier, according to embodiments described herein. In response to selection of the yes option 532 from FIG. 5, the user interface 630 may be provided. As illustrated, the user interface 630 may provide options 632, 634, 636 for communicating with the carrier. Specifically, the option 632 indicates that the package should be delivered as scheduled because someone will be at the house. The option 634 indicates to the carrier that the package should be delivered because the user vehicle 102 will be at the house with trunk access. Specifically, one or more identifiers of the user vehicle 102 may be provided such as the make, model, license number, color, location, etc. Additionally, some embodiments may provide an access code for accessing a portion of the user vehicle 102, such as the trunk. In some embodiments, the user vehicle 102 may include image recognition capabilities (such as via an image capture device) that may recognize the carrier and grant access accordingly. Regardless, such an option is beneficial with self-driving vehicles or other situations where a user may not be present. In response to selection of the option 636, an indication that someone will be present in the user vehicle 102 (and thus to deliver the package to the user vehicle 102) may be provided. At least one custom message may also be provided to the carrier.

It should be understood that options 634 and 636 may be utilized for other scenarios, such as when the carrier is delivering the package to a waypoint. Referring back to FIG. 3, if the package cannot be delivered to the predetermined destination, the carrier and/or the user may suggest a waypoint for the carrier to deliver the package. While in some embodiments, the waypoint may be a physical address, some embodiments may be utilized to deliver to the user vehicle 102 at a predetermined place (such as a parking lot, driveway, intersection, etc.). As such, the carrier vehicle 106 and the user vehicle 102 may exchange the desired location for making the delivery.

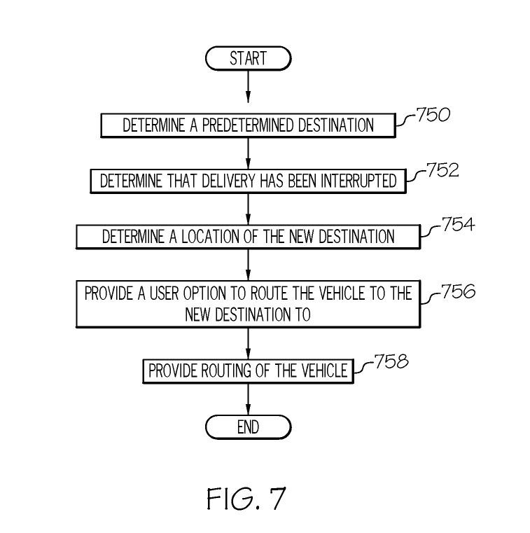

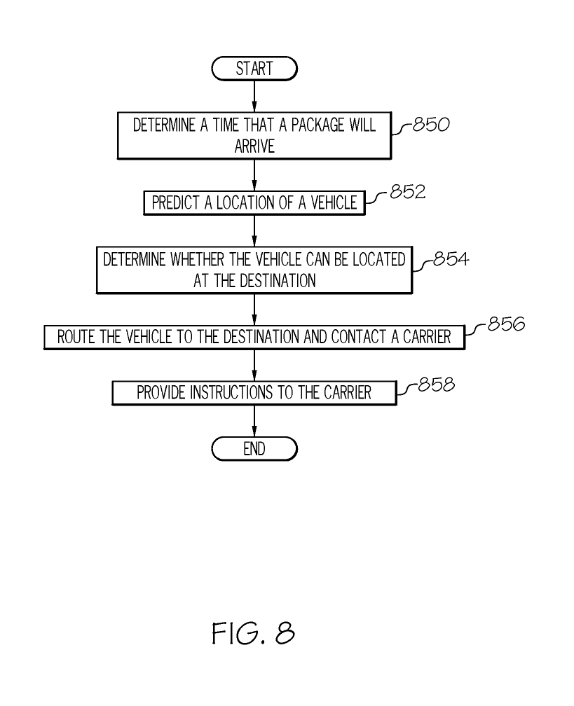

FIG. 7 depicts a flowchart for routing a user vehicle 102 to a package, according to embodiments described herein. As illustrated in block 750, a predetermined destination for delivering a package may be determined. In block 752, a determination that delivery of the package to the predetermined destination has been interrupted and the package is being delivered to a new destination. As discussed above, interruption of delivery may include the user not being located at the predetermined destination to receive the package, receiving a notification that the user will not be available to receive the package, a determination that the package cannot be delivered by the carrier at a scheduled time, and/or receiving a message from the user to deliver the package to the new destination, and/or for other reasons. Similarly, determining that delivery of the package has been interrupted includes receiving a message from the user requesting the package be delivered to the new destination, wherein the new destination is input by the user, and wherein the method further comprises determining whether the user vehicle 102 can be located at the new destination at a predetermined time.

Regardless, in block 754, a location of the new destination may be determined. In block 756, a user option to route the user vehicle 102 to the new destination to accept delivery of the package may be provided. In block 758, in response to a user selection of the user option, a routing of the user vehicle 102 to the new destination may be provided.

FIG. 8 depicts a flowchart for providing delivery instructions to a carrier, according to embodiments described herein. As illustrated in block 850, a time that a package will arrive at a predetermined destination may be determined. In block 852, a current location of a vehicle may be predicted. In block 854, a determination of whether the user vehicle 102 can be located at the predetermined destination at the time may be made. In block 856, in response to determining that the user vehicle 102 can be located at the predetermined destination at the time, the user vehicle 102 may be routed to the predetermined destination and the carrier may be contacted to indicate the presence of the user vehicle 102 at the predetermined destination. In block 858, in response to determining that the user vehicle 102 cannot be located at the predetermined destination at the time, instructions may be provided to the carrier. As discussed above, the instructions may include an instruction to leave the package at the predetermined destination, an instruction to reschedule delivery of the package to the predetermined destination, an instruction to deliver to a new destination, and/or other instructions.

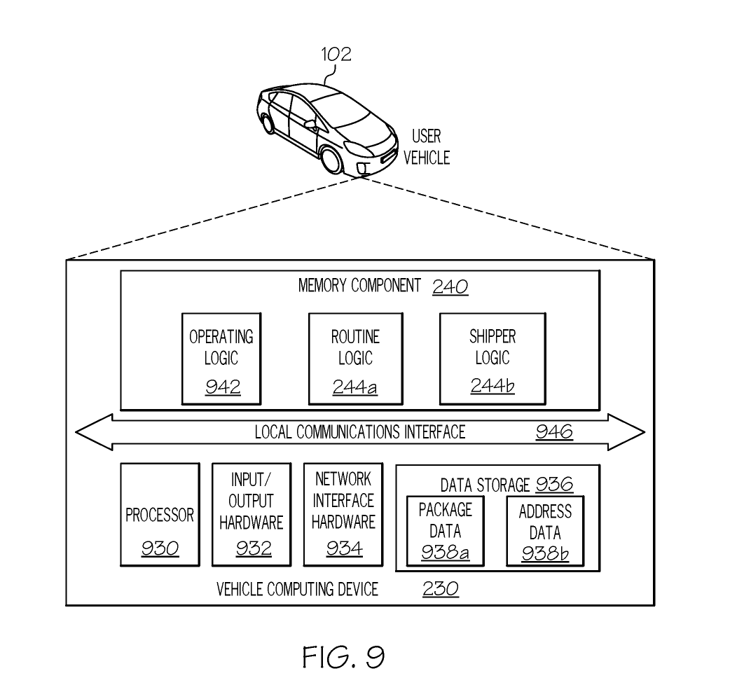

FIG. 9 depicts a vehicle computing device 230 for tracking a shipment, according to embodiments described herein. The vehicle computing device 230 includes a processor 930, input/output hardware 932, the network interface hardware 934, a data storage component 936 (which stores package data 938a, address data 938b, and/or other data), and the memory component 240. The memory component 240 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the vehicle computing device 230 and/or external to the vehicle computing device 230.

The memory component 240 may store operating logic 942, the routing logic 244a and the shipping logic 244b. The routing logic 244a and the shipping logic 244b may each include a plurality of different pieces of logic, each of which may be embodied as a computer program, firmware, and/or hardware, as an example. A local communications interface 946 is also included in FIG. 9 and may be implemented as a bus or other communication interface to facilitate communication among the components of the vehicle computing device 230.

The processor 930 may include any processing component operable to receive and execute instructions (such as from a data storage component 936 and/or the memory component 240). As described above, the input/output hardware 932 may include and/or be configured to interface with the components of the user vehicle 102, such as the vehicle head unit 204, the sensors, the motors, etc.

The network interface hardware 934 may include and/or be configured for communicating with any wired or wireless networking hardware, including an antenna, a modem, LAN port, wireless fidelity (Wi-Fi) card, WiMax card, Bluetooth chip, USB card, mobile communications hardware, and/or other hardware for communicating with other networks and/or devices. From this connection, communication may be facilitated between the vehicle computing device 230 and other computing devices, such as via the internet, to provide the functionality described herein.

The operating logic 942 may include an operating system and/or other software for managing components of the vehicle computing device 230. As also discussed above, the routing logic 244a may reside in the memory component 240 and may be configured to cause the processor 930 determine a location of the user vehicle 102, as well as route the user vehicle 102 to a predetermined destination (or other location). Similarly, the shipping logic 244b may be utilized to provide user interfaces, as well as communicate with the remote computing device 104 to facilitate the remaining functionality described herein.

It should be understood that while the components in FIG. 9 are illustrated as residing within the vehicle computing device 230, this is merely an example. In some embodiments, one or more of the components may reside external to the vehicle computing device 230. It should also be understood that, while the vehicle computing device 230 is illustrated as a single device, this is also merely an example. In some embodiments, the routing logic 244a and the shipping logic 244b may reside on different computing devices. As an example, one or more of the functionality and/or components described herein may be provided by another user computing device (such as a mobile device), the remote computing device 104, and/or a computing device associated with the carrier and/or carrier vehicle 106.

Additionally, while the vehicle computing device 230 is illustrated with the routing logic 244a and the shipping logic 244b as separate logical components, this is also an example. In some embodiments, a single piece of logic may cause the vehicle computing device 230 to provide the described functionality.

As illustrated above, various embodiments for tracking a shipment are disclosed. These embodiments may improve delivery time of packages to recipients, as well as reduce the costs incurred by carriers in multiple attempts to deliver a package.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for tracking a shipment. It should also be understood that these embodiments are merely exemplary and are not intended to limit the scope of this disclosure.

What is claimed is:

1. A method for tracking a shipment comprising:
determining, by a user computing device, a predetermined destination for delivery of a package for a user, wherein the package is being delivered by a carrier;
determining, by the user computing device, that delivery of the package to the predetermined destination has been interrupted and the package is being delivered to a new destination;
determining, by the user computing device, a location of the new destination;
providing, by the user computing device, a user option to route a vehicle to the new destination to retrieve the package; and
in response to a user selection of the user option, providing, by the user computing device, routing of the vehicle to the new destination.

2. The method of claim 1, wherein the new destination includes at least one of the following: a carrier facility or a user-defined destination.

3. The method of claim 1, further comprising:
receiving a predicted time that the package will be delivered to the new destination, wherein providing routing of the vehicle includes routing the vehicle to arrive at the new destination prior to the predicted time.

4. The method of claim 1, wherein the user computing device includes at least one of the following: a mobile device or a vehicle computing device.

5. The method of claim 1, further comprising indicating to the carrier that the vehicle will be located at the new destination to receive delivery.

6. The method of claim 1, further comprising providing an option to deliver the package to the predetermined destination at a different time.

7. The method of claim 1, wherein interruption of delivery of the package to the predetermined destination includes at least one of the following: the user not being located at the predetermined destination to receive the package, receiving a notification that the user will not be available to receive the package, a determination that the package cannot be delivered by the carrier at a scheduled time, or receiving a message from the user to deliver the package to the new destination.

8. The method of claim 1, wherein determining that delivery of the package has been interrupted includes receiving a message from the user requesting the package be delivered to the new destination, wherein the new destination is input by the user, and wherein the method further comprises determining whether the vehicle can be located at the new destination at a predetermined time.

9. The method of claim 1, further comprising:
determining a vehicle route of the vehicle; and
determining an added trip time to the route to include the predetermined destination to the route.

10. A system for tracking a shipment comprising:
a user computing device that includes a processor and a memory component that stores logic that, when executed by the processor, causes the system to perform at least the following:
determine a time that a package will arrive at a predetermined destination, wherein the package is being delivered by a carrier;
predict a current location of a vehicle;
determine whether the vehicle can be located at the predetermined destination at the time;
in response to determining that the vehicle can be located at the predetermined destination at the time, route the vehicle to the predetermined destination and indicate presence of the vehicle at the predetermined destination; and
in response to determining that the vehicle cannot be located at the predetermined destination at the time, provide instructions for the carrier.

11. The system of claim 10, wherein the instructions to the carrier include at least one of the following: an instruction to leave the package at the predetermined destination, an instruction to reschedule delivery of the package to the predetermined destination, or an instruction to deliver to a new destination.

12. The system of claim 10, wherein the user computing device includes at least one of the following: a mobile device or a vehicle computing device.

13. The system of claim 10, further comprising a remote computing device that performs at least the following:
receive the indication of the vehicle at the predetermined destination from the user computing device; and
communicate at least a portion of the indication with the carrier.

14. The system of claim 10, wherein the instructions for the carrier include a custom message to the carrier delivering the package.

15. The system of claim 10, wherein the logic further causes the system to perform at least the following:
determine a vehicle route of the vehicle; and
determine an added trip time to the vehicle route to include the predetermined destination to the vehicle route.

16. A vehicle computing device comprising:
a processor; and
a memory component that is coupled to the processor and stores logic that, when executed by the processor, causes the vehicle computing device to perform at least the following:
determine a predetermined destination and a predetermined time for delivery of a package for a user, wherein the package is being delivered by a carrier;
determine that the package cannot be delivered to the predetermined destination at the predetermined time;
in response to determining that the package cannot be delivered, determine a new destination and a different time for delivering the package;
provide a user option to route a vehicle to the new destination to retrieve the package at the new destination and the different time; and
in response to a user selection of the user option, provide routing of the vehicle to the new destination.

17. The vehicle computing device of claim 16, wherein the new destination includes at least one of the following: a carrier facility or a user-defined destination.

18. The vehicle computing device of claim 16, wherein the logic further causes the vehicle computing device to indicate to the carrier that the vehicle will be located at the new destination to receive delivery.

19. The vehicle computing device of claim 16, wherein the package cannot be delivered due to at least one of the following: the carrier being unable to deliver or receiving a message from the user to deliver the package to the new destination.

20. The vehicle computing device of claim 16, wherein the logic further causes the vehicle computing device to perform at least the following:
determine a vehicle route of the vehicle; and
determine an added trip time to the route to include the predetermined destination to the route.
